(19) United States
(12) Patent Application Publication
(10) Pub. No.: US 2012/0268349 A1
(43) Pub. Date: Oct. 25, 2012

(54) MULTIDISPLAY DEVICE

(76) Inventors: Rika Hayashi, Osaka (JP); Tatsuo Imafuku, Osaka (JP); Nobuyuki Yoshioka, Osaka (JP); Ayae Nagaoka, Osaka (JP); Masanobu Deguchi, Osaka (JP)

(21) Appl. No.: 13/413,761

(22) Filed: Mar. 7, 2012

(30) Foreign Application Priority Data
Apr. 21, 2011 (JP) 2011-094926

(51) Int. Cl. G09G 5/00

(52) U.S. Cl. 345/1.1

(57) ABSTRACT

A multidisplay device includes: a first flat display element and a second flat display element arranged such that sides thereof are coupled to face each other, and having a boundary portion at a portion where the sides are coupled to each other; and a lenticular lens provided to cover the boundary portion and to cover a row of pixels including a red pixel, a green pixel and a blue pixel arranged side by side adjacent to the boundary portion. Observers are even less likely to become aware of the fact that the plurality of flat display elements are coupled to one another.

This nonprovisional application is based on Japanese Patent Application No. 2011-094926 filed on Apr. 21, 2011 with the Japan Patent Office, the entire contents of which are hereby incorporated by reference.

### BACKGROUND OF THE INVENTION

1. Field of the Invention

The present invention relates to a multidisplay device, and particularly to a multidisplay device including a plurality of flat display elements.

2. Description of the Background Art

A liquid crystal display (LCD), a thin film transistor (TFT)-LCD, a field emission display (FED), a plasma display panel (PDP), an electro-luminescent (EL) display and the like have been known as a flat display element that is a substitute for a cathode-ray tube.

The flat display element is employed in various types of electronic equipment such as a wall-hanging display device, a notebook computer or a personal digital assistant (PDA). In recent years, such flat display element tends to increase in size along with increase in size of a window screen and the like of a monitor constituting these various types of electronic equipment. When the large-sized window screen and the like of the monitor are formed by a single product, the fabrication cost becomes high. On the other hand, in the flat display element used in small equipment focused on portability and the like, realization of a large-sized screen is difficult because of narrow available space.

In view of the above problems, Japanese Patent Laying-Open No. 2001-005414 discloses a multidisplay device having a foldable middle portion to achieve a large-sized screen and multi driving while reducing the size of a flat display element. As disclosed in this literature, a plurality of flat display elements are coupled to one another in the multidisplay device.

### SUMMARY OF THE INVENTION

In the multidisplay device, it is important in enhancing the quality to make observers unaware of the fact that the plurality of flat display elements are coupled to one another.

An object of the present invention is to provide a multidisplay device configured to further make observers unaware of the fact that a plurality of flat display elements are coupled to one another.

A multidisplay device according to the present invention includes: a first flat display element and a second flat display element arranged such that sides thereof are coupled to face each other, and having a boundary portion at a portion where the sides are coupled to each other; and a lenticular lens provided to cover the boundary portion and to cover a row of pixels including a red pixel, a green pixel and a blue pixel arranged side by side adjacent to the boundary portion.

Preferably, the first flat display element and the second flat display element are each a liquid crystal display, a field emission display, a plasma display, or an electro-luminescent display.

Preferably, the lenticular lens is formed of a transparent member. Preferably, the transparent member forming the lenticular lens is made of a resin.

Preferably, a transparent film is formed at a region of the first flat display element and the second flat display element that is not covered with the lenticular lens.

Preferably, the lenticular lens is disposed in a direction parallel to an arrangement direction of the first flat display element and the second flat display element.

Preferably, the lenticular lens is located immediately on a joint portion where the sides of the first flat display element and the second flat display element are coupled to each other.

According to the present invention, there can be obtained a multidisplay device configured to further make observers unaware of the fact that a plurality of flat display elements are coupled to one another.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing a multidisplay device according to an embodiment.

FIG. 2 is a cross-sectional view taken along line II-II in FIG. 1.

FIG. 3 is an enlarged cross-sectional view showing one flat display element used in the multidisplay device according to the embodiment.

FIG. 4 is a cross-sectional view showing a multidisplay device according to a first modification of the embodiment.

FIG. 5 is a cross-sectional view showing a multidisplay device according to a second modification of the embodiment.

### DESCRIPTION OF THE PREFERRED EMBODIMENTS

A multidisplay device according to an embodiment of the present invention will be described hereinafter with reference to the drawings. The present invention is applicable to a multidisplay device having a plurality of flat display elements coupled to one another. The following description of the embodiment will be given based on a multidisplay device having two flat display elements coupled to each other.

In the embodiment described below, descriptions of numbers, amounts and the like are not intended to limit the scope of the invention unless otherwise specified. In the embodiment described below, the same or corresponding components are denoted with the same reference numerals, and the same description will not be repeated.

### Embodiment

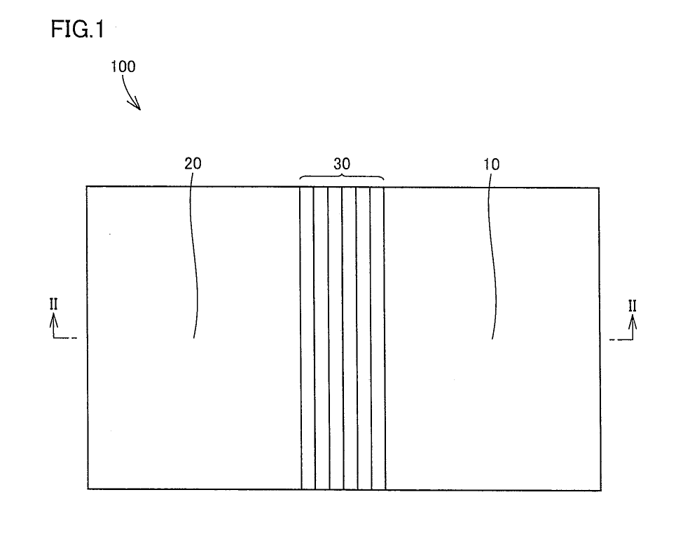

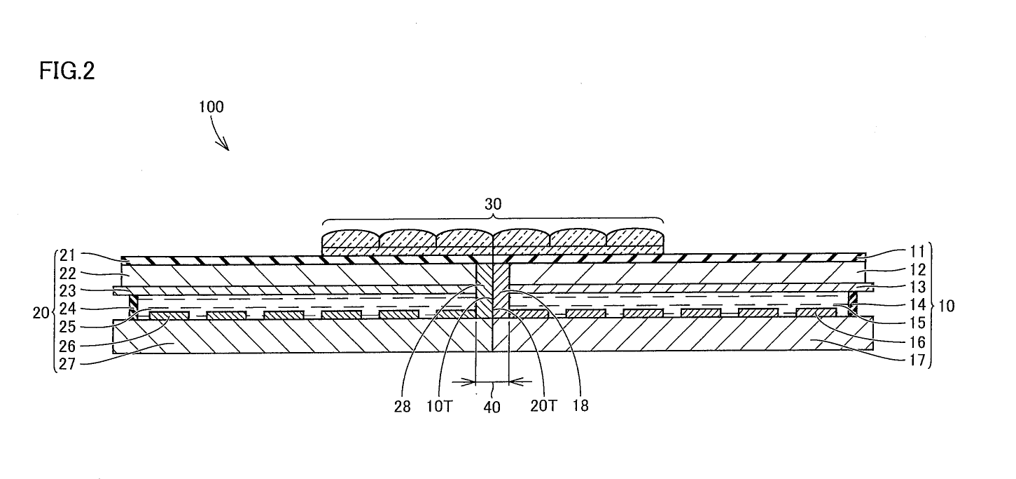

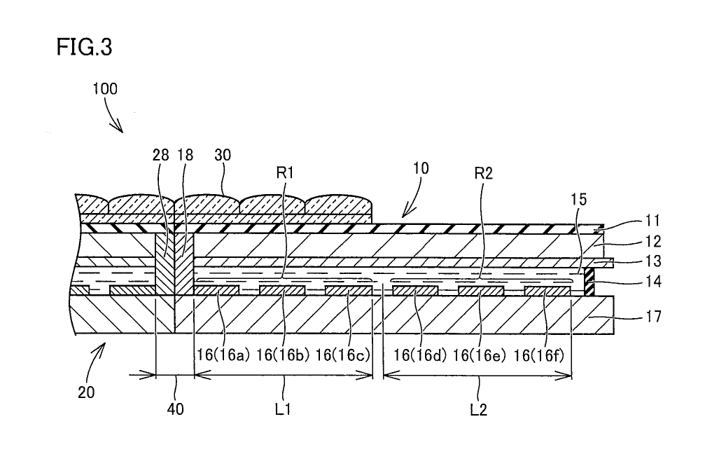

A multidisplay device 100 according to the present embodiment will be described with reference to FIGS. 1 to 3. FIG. 1 is a plan view showing multidisplay device 100. FIG. 2 is a cross-sectional view taken along line in FIG. 1. FIG. 3 is an enlarged cross-sectional view showing a flat display element 10 used in multidisplay device 100.

As shown in FIG. 1, multidisplay device 100 includes a flat display element 10 (first flat display element), a flat display element 20 (second flat display element) and a lenticular lens 30. Flat display element 10 and flat display element 20 are each, for example, a liquid crystal display (LCD).

A thin film transistor (TFT)-LCD, a field emission display (FED), a plasma display panel (PDP), an electro-luminescent (EL) display, or other flat panel displays may be used as flat display element 10 and flat display element 20.

Referring to FIG. 2, in flat display element 10, a pair of a substrate 12 and a substrate 17 are arranged to face each other. On the inner surface sides of substrate 12 and substrate 17, a transparent electrode 13 and a transparent electrode 16 as well as an insulating layer (not shown) and an orientation layer (not shown) are stacked, respectively. An internal space sealed by a sealant 14 is filled with a liquid crystal substance 15. A protective film 11 is attached to surfaces of a sidewall 18 and substrate 12.

Similarly, in flat display element 20, a pair of a substrate 22 and a substrate 27 are arranged to face each other. On the inner surface sides of substrate 22 and substrate 27, a transparent electrode 23 and a transparent electrode 26 as well as an insulating layer (not shown) and an orientation layer (not shown) are stacked, respectively. An internal space sealed by a sealant 24 is filled with a liquid crystal substance 25. A protective film 21 is attached to surfaces of a sidewall 28 and substrate 22.

A side 10T of flat display element 10 and a side 20T of flat display element 20 are coupled to face each other. Side 10T of flat display element 10 and side 20T of flat display element 20 are coupled by not-shown coupling means. Flat display element 10 and flat display element 20 may be configured to be pivotable or retractable with respect to each other.

A coupling portion 40 is formed at a portion where side 10T of flat display element 10 and side 20T of flat display element 20 are coupled to each other. Coupling portion 40 is a portion that does not contribute to image display by liquid crystals. Coupling portion 40 has a width of, for example, 6 to 10 mm.

Referring to FIG. 3, lenticular lens 30 is provided to cover coupling portion 40 and to cover a row of pixels (16a to 16c) including a red (R) pixel, a green (G) pixel and a blue (B) pixel arranged side by side adjacent to coupling portion 40. Lenticular lens 30 is disposed in a direction parallel to the arrangement direction of flat display elements 10 and 20 (vertical direction on the sheet of FIG. 3).

In other words, lenticular lens 30 is arranged to cover coupling portion 40 and is arranged on a surface of a region RI including the red (R) pixel (pixel 16a), the green (G) pixel (pixel 16b) and the blue (B) pixel (pixel 16c) arranged side by side adjacent to coupling portion 40. Pixels 16a to 16c are portions where upper transparent electrode 13 and lower transparent electrode 16 intersect with each other, and are a minimum unit forming an image.

The region covered with lenticular lens 30 includes coupling portion 40, and a row of pixels 16a to 16c having the red (R) pixel, the green (G) pixel and the blue (B) pixel. When the magnification of lenticular lens 30 is 1.35, transparent electrode 16 constituting pixels 16d to 16f in a region R2 that is not covered with lenticular lens 30 has a width of 0.3 mm, and a space between the pixels has a width of 0.03 mm, a screen length L1 of the region that can be looked at through lenticular lens 30 can be obtained from the following equation:

L1=L2/1.35={(0.3×3)+(0.03×3)}/1.35=0.733

It can be seen from this equation that length L1 of the region covered with lenticular lens 30 is smaller by approximately 26% than a length L2 of region R2 that is not covered with lenticular lens 30. The magnification of lenticular lens 30 and length L1 are inversely proportional to each other and vary depending on the number of pixels 16a to 16c included therein.

In lenticular lens 30 arranged as described above, coupling portion 40 can be visually minimized by the effect of the magnification and the refractive index of the lens when flat display elements 10 and 20 display an image. At this time, by the effect of the magnification of lenticular lens 30, pixels 16a to 16c in scaled-down region R1 are scaled up and displayed to have the same size as that of pixels 16d to 16f in the other region R2. Therefore, the quality of the entire screen of multidisplay device 100 can be enhanced.

Lenticular lens 30 guides a path of display light emitted onto the screen of flat display elements 10 and 20 such that the path is inclined toward a center of coupling portion 40, and emits the display light. Lenticular lens 30 may be configured to scale up the display light emitted onto the screen at an optimum magnification. Due to the orientation and scale-up by lenticular lens 30, coupling portion 40 (portion that does not contribute to image display by liquid crystals) becomes hardly noticeable when observers look at multidisplay device 100. Coupling portion 40 is visually compensated and is not displayed externally. According to multidisplay device 100, observers are hardly aware of the fact that flat display elements 10 and 20 are coupled to each other, and flat display element 10 and flat display element 20 can be recognized as one display.

Lenticular lens 30 used in multidisplay device 100 according to the present embodiment is made of, for example, a resin. A transparent resin such as, for example, an acrylic resin or a polycarbonate resin may be used as the resin making lenticular lens 30.

In order to manufacture lenticular lens 30, an outer frame and a mold having the shape corresponding to the lens shape of lenticular lens 30 are prepared. A liquid-state resin material for forming lenticular lens 30 is injected and charged into the mold, with the mold fixed to the outer frame. The liquid-state resin material for forming lenticular lens 30 is cured, and thereby lenticular lens 30 is formed in the mold. The mold is then removed. Thus, lenticular lens 30 can be obtained.

As a method for manufacturing lenticular lens 30, a lens may be instantaneously molded and solidified using an UV curable ink and the like (in other words, after printing in the form of lens on coupling portion 40, UV may be applied for curing). In this case, lenticular lens 30 may be made of a versatile resin such as PET or polycarbonate, although lenticular lens 30 contains, as an ingredient, only a small amount of low-molecular-weight polymer as well.

Lenticular lens 30 is preferably formed of a transparent member. Lenticular lens 30 may, however, be formed of a slightly-colored thin lens.

### First Modification of Embodiment

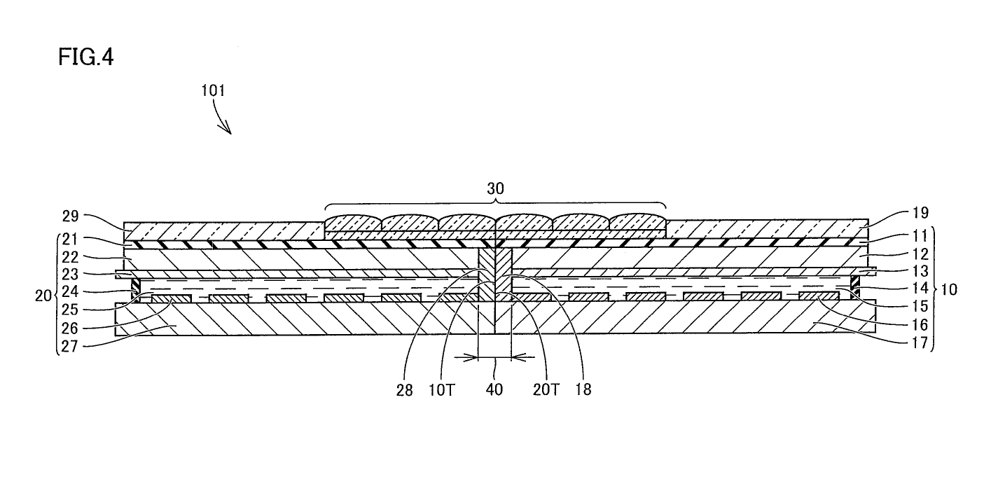

FIG. 4 is a cross-sectional view showing a multidisplay device 101 according to a first modification of the embodiment.

As in multidisplay device 101, transparent films 19 and 29 may be formed at a portion where lenticular lens 30 is not disposed. Formation of transparent films 19 and 29 makes less noticeable a visual difference between the portion where lenticular lens 30 is disposed and the portion where lenticular lens 30 is not disposed.

The same material as that of lenticular lens 30 can be used in transparent films 19 and 29. Transparent films 19 and 29 are preferably manufactured from one material and formed to be flat. Transparent films 19 and 29 may, however, be made of other materials as long as elimination of height difference is possible.

### Second Modification of Embodiment

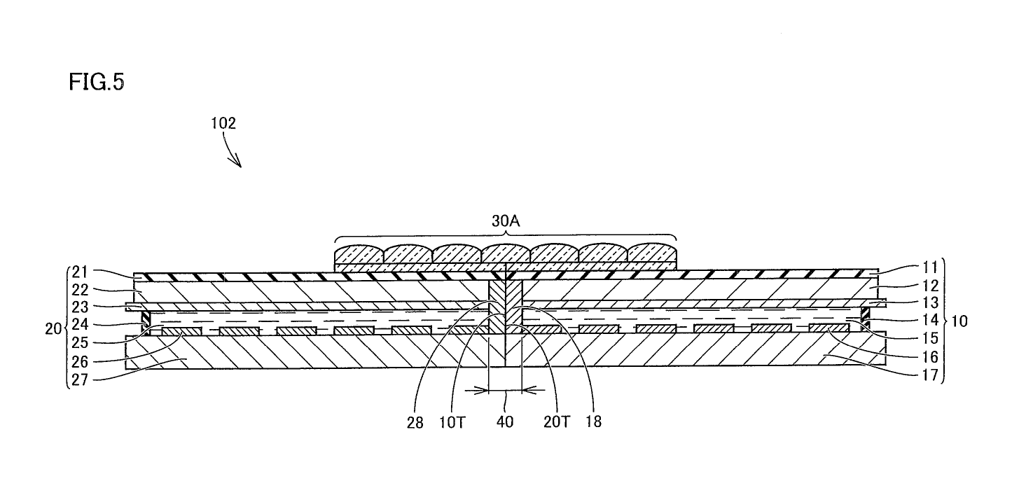

FIG. 5 is a cross-sectional view showing a multidisplay device 102 according to a second modification of the embodiment.

As in multidisplay device 102, one lenticular lens 30A may be arranged immediately on a portion (joint portion) where side 10T of flat display element 10 and side 20T of flat display element 20 are coupled to each other. In this case, a convexly-formed portion of one lenticular lens 30A may be located immediately on this joint portion.

With such a configuration, observers are even less likely to become aware of the fact that flat display elements 10 and 20 are coupled to each other.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A multidisplay device, comprising:
a first flat display element and a second flat display element arranged such that sides thereof are coupled to face each other, and having a boundary portion at a portion where said sides are coupled to each other; and
a lenticular lens provided to cover said boundary portion and to cover a row of pixels including a red pixel, a green pixel and a blue pixel arranged side by side adjacent to said boundary portion.

2. The multidisplay device according to claim 1, wherein
a transparent film is formed at a region of said first flat display element and said second flat display element that is not covered with said lenticular lens.

3. The multidisplay device according to claim 1, wherein
said lenticular lens is disposed in a direction parallel to an arrangement direction of said first flat display element and said second flat display element.

4. The multidisplay device according to claim 1, wherein
said lenticular lens is located immediately on a joint portion where said sides of said first flat display element and said second flat display element are coupled to each other.
